(19) United States
(12) Patent Application Publication
(10) Pub. No.: US 2025/0341823 A1
(43) Pub. Date: Nov. 6, 2025

(54) COMPUTER-IMPLEMENTED METHOD AND DEVICE FOR VERIFYING CORRECTNESS OF ASSEMBLY

(71) Applicant: Carl Zeiss AG, Oberkochen (DE)

(72) Inventors: Matthias Karl, Königsbronn (DE); Ghazal Ghazaei, München (DE)

(73) Assignee: Carl Zeiss AG, Oberkochen (DE)

(21) Appl. No.: 19/270,495

(22) Filed: Jul. 16, 2025

Related U.S. Application Data
(63) Continuation of application No. PCT/EP2023/087908, filed on Dec. 28, 2023.

(30) Foreign Application Priority Data
Jan. 30, 2023 (DE) 10 2023 102 196.6

(51) Int. Cl. G05B 19/418

(52) U.S. Cl. CPC G05B 19/41875; G05B 2219/32368; G05B 2219/35134

(57) ABSTRACT

A computer-implemented method configured to check a correctness of an assembly is provided, wherein the method comprises determining an actual 3D model of the assembly based on image data relating to the assembly, and comparing the determined actual 3D model with a target 3D model of the assembly to check the correctness of the assembly.

### CROSS REFERENCE TO RELATED APPLICATIONS

This application is a continuation application of international patent application PCT/EP2023/087908, filed on Dec. 28, 2023, and designating the U.S., which claims priority to German patent application 10 2023 102 196.6 filed on Jan. 30, 2023, both of which are hereby incorporated by reference in their entireties.

### TECHNICAL FIELD

The present disclosure relates to a computer-implemented method configured to check the correctness of an assembly. The disclosure also provides a data processing device configured to carry out the method at least in part. The disclosure also provides a computer program comprising instructions which, when the program is executed by a computer, cause the latter to carry out the method at least in part. The disclosure also provides a computer-readable medium comprising instructions which, when the instructions are executed by a computer, cause the latter to carry out the method at least in part.

### BACKGROUND

The discussion of the prior art in the description shall in no way be construed as an admission that this prior art is generally known or is part of the general knowledge in the technical field of this disclosure.

In an installation process, in particular of a complex assembly, as is often the case, for example, in machinery and plant engineering, errors can occur when installing the components that form the assembly. Depending on the application and the apparatus, such an error can result in production downtimes and, among other things, a significant post-processing effort for a manufacturer of the assembly, after delivery of the assembly to a customer.

Conventionally, assemblies are therefore evaluated manually by one or more human quality inspectors (so-called end-of-line test) in order to assess the quality of the installation in terms of whether the correct components have been installed, whether the installed components are complete (that is to say whether all components have been installed) and whether alignment of all components involved, for example in relation to one another, is correct. Such a manual procedure is time-consuming and may be susceptible to errors.

Therefore, the prior art describes automated solutions for checking the correctness of an assembly.

In this context, reference is made to U.S. Pat. No. 9,187,188 B2 and U.S. Pat. No. 10,242,438 B2.

U.S. Pat. No. 9,187,188 B2 relates to a method for inspecting an assembly of components in an aircraft structure. The method comprises acquiring a visual representation of at least a part of the structure comprising a plurality of components, storing an electronic file of the visual representation on a computer-readable medium and accessing a three-dimensional model of the structure, wherein the three-dimensional model contains information about a correct or desired position of each of the plurality of components within the structure. The method further comprises comparing the acquired visual representation with the three-dimensional design using a computer by graphically superimposing an image relating to the visual representation with a second image relating to the three-dimensional design in order to determine whether each of the multiple components included in the visual representation is in a correct position in the structure as determined by a position of each corresponding component included in the three-dimensional design. The method ultimately comprises generating feedback that indicates a result of the comparison.

U.S. Pat. No. 10,242,438 B2 describes a method for determining whether or not an installation of an assembly was successful, and, as part of this method, a method for determining the position and orientation of component parts of the assembly. The method for determining whether or not an installation of an assembly was successful comprises the three steps described below. The first step is to capture a grayscale image and a range image (that is to say an image with depth information) of the assembly. A second step is to determine the position and the orientation of the component parts of the assembly based on the two captured images and a 3D model of the assembly. A third step is to determine whether or not the installation of the assembly was successful, based on the determined position and orientation. In the second step, edges extracted from the captured grayscale image and depth points contained in the range image are iteratively aligned with the 3D model of the assembly as best as possible in order to determine the position and orientation of the component parts of the assembly so that, on this basis, a deviation of the shape of the assembly from the 3D model is determined so that a comparison of the determined deviation with a limit value in the subsequent third step of the method can be used to determine whether or not the installation of an assembly was successful.

A disadvantage of the procedure according to U.S. Pat. No. 9,187,188 B2 as well as U.S. Pat. No. 10,242,438 B2 is that, according to the teaching of both documents, the assembly can be viewed only from one perspective, and so this described procedure is stretched to its limits in the case of complex assemblies, as is usually the case, for example, in machinery and plant engineering, to such an extent that, for such complex assemblies, the method would have to be carried out for a plurality of different perspectives, which in turn is very time-consuming and computationally intensive. Since both methods use perspective projections on a 2D image plane that do not fully reproduce the 3D reality, inspection positions that do not allow quick or intuitive use or implementation typically need to be predefined in order to minimize a number of perspectives required for the inspection.

DE 10 2020 134 680 A1 relates to a method for quality testing an object of a real environment using a camera, an optical display apparatus and a processing device. The method comprises the following steps: defining a test geometry and a reference geometry within a computer-assisted data model, defining a test pose in which the camera should be placed by a user as target positioning for a quality test to be carried out on the object to be tested, and visualizing the test pose on the optical display apparatus. In a second phase, at least one image of the real environment is captured by the camera, the pose of which camera is in a range that includes the test pose, and the test geometry and the reference geometry in the image are tracked. Furthermore, a pose of the tracked test geometry in relation to the reference geometry and at least one parameter are determined on the basis of how the pose of the tracked test geometry is related to a target pose of the test geometry defined in the data model. A quality indicator is also determined on the basis of the at least one parameter and is output to the user via a human-machine interface.

The teaching of DE 10 2020 134 680 A1, as well as U.S. Pat. No. 9,187,188 B2 and U.S. Pat. No. 10,242,438 B2, therefore requires predefined observation perspectives or inspection poses depending on the specific component part to be tested, which limits a field of application of the method or makes the use thereof inflexible.

### SUMMARY

A computer-implemented method configured to check a correctness of an assembly is provided, wherein the method comprises determining an actual 3D model of the assembly based on image data relating to the assembly, and comparing the determined actual 3D model with a target 3D model of the assembly to check the correctness of the assembly.

### BRIEF DESCRIPTION OF THE DRAWINGS

In the drawings:

FIG. 1 schematically shows a data processing system configured to carry out a computer-implemented method according to the disclosure, which in turn is configured to check the correctness of an assembly, and

FIG. 2 schematically shows a flowchart of this method.

### DETAILED DESCRIPTION

In the following, details are set forth to provide a more thorough explanation of the disclosure. However, it will be apparent to those skilled in the art that these implementations may be practiced without these specific details. In other instances, well-known structures and devices are shown in block diagram form or in a schematic view rather than in detail in order to avoid obscuring the disclosure. In addition, features described hereinafter may be combined with each other, even if described with respect to different figures, unless specifically noted otherwise.

Equivalent or like elements or elements with equivalent or like functionality are denoted in the following description with equivalent or like reference numerals. As the same or functionally equivalent elements are given the equivalent or like reference numbers in the figures, a repeated description for elements provided with the equivalent or like reference numbers may be omitted. Hence, descriptions provided for elements having the equivalent or like reference numbers are mutually exchangeable.

Directional terminology, such as “top,” “bottom,” “below,” “above,” “front,” “behind,” “back,” “leading,” “trailing,” etc., may be used with reference to the orientation of the figures being described. Because parts of the disclosure, described herein, can be positioned in a number of different orientations, the directional terminology is used for purposes of illustration and is in no way limiting. It is to be understood that other implementations may be utilized, and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

The terms “substantially” and “approximately” may be used herein to account for small manufacturing tolerances (e.g., within 5%) that are deemed acceptable in the industry without departing from the aspects of the implementations described herein. For example, a resistor with an approximate resistance value may practically have a resistance within 5% of that approximate resistance value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

A specific embodiment of the disclosure can provide a solution for automated verification of a correctness of a complex assembly, e.g. as seen inter alia in machinery and plant engineering.

Therefore, a computer-implemented method configured to check the correctness of an assembly is provided. The method comprises determining an actual 3D model of the assembly based on image data relating to the assembly, and comparing the determined actual 3D model with a target 3D model of the assembly to check the correctness of the assembly.

A computer-implemented method can be understood to mean a method in which one step, multiple steps or all steps of the method are carried out or executed at least in part by a data processing device or a computer.

An automated solution for checking an assembly is therefore proposed. It is conceivable in this case that the assembly in question is also scanned automatically and/or manually, for example using a mobile apparatus, and feedback on the quality of the installation can be automatically output, for example via a display of the mobile terminal.

The image data initially represents 2D or 2.5D information regarding the assembly, which is then converted into 3D information. It is conceivable that the image data includes depth information (for example as a depth map) and/or images (for example RGB images). Both can be captured or recorded from one or more perspectives. Depth images (even with inaccurate depth resolution) can resolve ambiguous scenes and/or depth-scaling ambiguity when a single camera is used. Synchronous acquisition of depth images with image data can therefore supplement a perspective estimate of a (mobile) camera in order to obtain more robust or faster convergence. It is conceivable that one or more mobile and compact sensors, such as an RGB-D depth camera (RGB-D can be understood as a colored point cloud), a solid-state lidar or similar, will be used for this purpose. In other words, the image data can be acquired in various modalities, for example by means of a monochrome and/or color camera, a depth sensor, a lidar/ToF sensor and/or other or additional 3D sensors, which for example use a pattern/stripe projection and/or comprise a laser scanner. The use of 2D/RGB information has-inter alia-the advantage that sensitivity to 3D sensor noise is comparatively low, so that even relatively dark, small and/or shiny components can be reliably captured. It should also be noted that dark areas and small components can be easily captured or accessed using a mobile camera. For shiny objects, the use of different perspectives may be beneficial.

The assembly is an object that exists in the real world. The assembly is an assembly group (according to DIN 199, group for short), which is a self-contained object consisting of two or more parts or assemblies of a lower order, which can usually be dismantled again. A single part, on the other hand, can be distinguished from the assembly insofar as it cannot be dismantled without any damage (see DIN 199 Technical Product Documentation). In other words, the assembly has multiple single parts that may be combined into subassemblies.

The term “component” used below therefore refers to a single part as well as to subassemblies comprising multiple single parts, each of which is part of the assembly.

The term “correctness” can be broadly understood in relation to the assembly, given the above definition of the assembly, and, inter alia, can refer to the completeness of the assembly with respect to the individual components that form the assembly. In addition or as an alternative, the correctness of the installed components can be checked with regard to whether the correct component is installed at all and/or whether the installed component is installed correctly, i.e. whether the installed component is installed in the correct position, for example. Checking whether the correct component is installed can also ensure that no component has been mixed up. Because similar components with slightly different dimensions are typically available for other series or processes in installation, such an exclusion of changes is advantageous.

The correctness is defined or stipulated in the present case by means of the target state. A prefixed ‘target’, such as in the target 3D model (also used below for position and orientation), therefore identifies the desired state that is to be represented or achieved by the actual state, so that the check for correctness can be affirmed if the actual state and the target state match, and can be negated if the above-mentioned states differ. Consequently, the actual state describes the actual physical state of the assembly in the real world, said state being achieved, for example, through the installation of the assembly.

The comparison step can therefore also be understood as a target-actual comparison, in which the correctness of the assembly is checked.

In contrast to the prior art, the disclosed method offers a number of advantages. Among other things, the method allows a three-dimensional (3D) check of the assembly for correctness and is therefore also suitable for checking complex assemblies in which conventional methods reach their limits.

In detail: A model can be understood in the present case as a computer model that represents—as a so-called “digital twin”—a simplified image of reality or the assembly. The model used in accordance with the disclosure is at least three-dimensional, i.e. it essentially reflects the external dimensions of the assembly spatially. Therefore, the assembly can be viewed from different perspectives or angles and can thus also be checked from different angles. The conventional methods described at the outset, on the other hand, use a perspective 2D model (i.e. an image) in the case of U.S. Pat. No. 9,187,188 B2 and a 2.5D model (i.e. an image paired with depth information) in the case of U.S. Pat. No. 10,242,438 B2, of the assembly, which means that only the part of the assembly that is visible in the field of view (FoV) of the camera used in each case can be checked for correctness at a time. If the object or the assembly to be checked is to be checked using conventional methods from two different directions or perspectives, for example a front side and a rear side of the assembly, the conventional method in question must be completed twice-once with the camera facing the front side and once facing the rear side, with the respective calculation of the 2D or 2.5D model. As an alternative thereto, it appears to be sufficient in accordance with the disclosure to generate the 3D model of the assembly only once in order to be able to carry out a comprehensive check of the assembly from different perspectives by comparing the actual 3D model with the target 3D model, wherein the comparison step with the method according to the disclosure must also be carried out only once and not separately for each perspective, as is customary.

The use of the 3D model offers, inter alia, the technical effect, compared to the use of the 2D or 2.5D model, for example, that only a single target-actual comparison step can be performed using a single (virtual or digital) model to be calculated of the assembly to be checked in order to verify the correctness of a complex assembly part or complex assembly from multiple perspectives.

Consequently, proceeding from the prior art, a person skilled in the art may be faced with the objective technical problem of modifying methods known from the prior art, as described, for example, in U.S. Pat. No. 9,187,188 B2 or U.S. Pat. No. 10,242,438 B2, in such a way that a complex assembly can be checked from multiple perspectives with only one single target-actual comparison step by using a single model (virtual or digital) to be calculated of the assembly to be checked.

This is achieved according to the disclosure, as explained in detail above, at least by using the 3D model. Such a procedure or the solution according to the disclosure is neither known from the prior art nor is it suggested to a person skilled in the art.

What has been described above can be described as not limiting to the disclosure as follows and summarized in relation to a specific embodiment of the teaching according to the disclosure: First, image data of the assembly, for example in the form of a video stream or one or more individual images, can be acquired. It is then possible to detect and identify single parts (the visible casing) of the assembly in 2D. This may include a prediction of a 2D object center and a pose (for example by means of a rotation matrix), as well as a 2D segmentation mask in the video image or in the individual image capture. Especially when a video stream is available, the predicted object position can be optimized based on multiple (perspective) predictions. The most similar CAD model can in each case be selected from a database based on a similarity in an appearance embedding space and the position of the identified component can be detected in relation to other component parts in the surroundings of the identified component. This can be repeated for all detected components. Now the assembly can be created virtually as a 3D model with all the detected components and their poses in relation to one another. Finally, the virtual 3D model can be compared with the digital 3D model of the assembly and thus missing, misaligned and incorrect components of the assembly can be identified.

In the following text, possible developments of the above method are explained in detail, with these developments individually, but also in combination, at least reinforcing the advantages of the method that are described above.

The method may comprise identifying, in the image data, multiple components that form the assembly, and determining, based on the image data, an actual position and actual orientation of the identified components relative to one another and/or with respect to a predetermined camera perspective from which the image data was acquired.

In the context of the identification, a presence of an object or a component, for example a single component part and/or an assembly group comprising multiple component parts of the assembly, can be detected in the image data and it is possible to determine what type or more specifically what component from a large number of previously known or predetermined components is involved. The presence can be understood more specifically as meaning, for example, that the respective component to be identified can be seen in a visualization of the image data and therefore can or should be recognized by means of an algorithm, for example an object recognition algorithm.

An actual position can be understood as the position, for example, of a geometric center and/or center of gravity, of a component in space in the real world. An actual orientation can be understood as meaning an orientation of this component in space in the real world. What has been described above applies analogously to the target position and the target orientation, which are contained in the target 3D model as information and can be extracted directly or at least indirectly therefrom by means of the method.

A camera perspective can be understood as meaning a viewing angle of a camera on the assembly. The method is not limited to a variation of the camera perspective, but also, in addition or alternatively, a field of view of the camera can be varied in terms of a size (i.e. the assembly can be viewed in sections and/or completely) and/or a distance of the camera from the assembly (for example virtually via a zoom and/or physically by actually reducing or increasing the distance of the camera from the assembly).

Identifying the components and determining the actual position and actual orientation thereof provides-inter alia-the technical effect that a check for correctness is possible for each of the components that form the assembly. This means that it is possible to check component-by-component for the correctness of the assembly (as explained in more detail below) so that-this being particularly advantageous for complex assemblies-not only is it indicated that the target 3D model as a whole does not match the actual 3D model, but rather it is possible to indicate which components are incorrect. This enables targeted reworking and/or manual verification of the assembly (for example as part of a guided user interaction).

It is conceivable that the identification of the components follows a multi-level approach. This may mean that, in a first step, components that are larger than a predefined threshold value are first identified. In a second step, objects that are smaller than the predefined threshold value can then be identified. To this end, in the second step, it is possible to use image data that, compared to the image data used in the first step, were acquired with a higher zoom level or with a smaller distance between the camera and the assembly. The first and second steps can be carried out sequentially or at least partially simultaneously.

The multiple components can be identified and/or the position and orientation of the identified components can be determined by means of an, optionally single, model that is based on artificial intelligence (for example comprising one or more artificial neural networks). The model can be trained to, optionally simultaneously, identify individual components from a pool of components and/or determine the actual position and actual orientation of said components from the image data relating to the assembly.

More specifically, the model can be used, for example, to perform 2D instance segmentation of components that are available in a pool of possible components. The pool of possible components in this case defines the so-called embedding space. Component recognition and segmentation can be performed by means of the trained model, this being made possible by prior learning from 2D projections (views) of 3D CAD models of the components. Methods such as multi-object recognition including object pose recognition (i.e. actual position and actual orientation) can be used, with the model being trained so that it can identify the respective components even if the components in the image data are partially covered due to an installation state of the component on the assembly and/or a respective camera perspective and can determine the actual position and actual orientation thereof.

It is conceivable that previously trained keypoints are estimated in views that describe the 3D bounding box of the object, for example, for the estimation of object poses (or for the determination of the actual orientation). These estimated keypoints can represent an intermediate result that ultimately determines the object perspective or object pose.

It is conceivable that the model is also designed or trained in such a way that it determines an uncertainty or ambiguity of a result of identifying and determining the actual position and the actual orientation of the individual components, i.e. a probability that the component and the actual position and actual orientation thereof have been correctly detected. In other words, in addition to identification and/or the pose, an ML network can also learn how certain or likely a result is. This may correspond to a reliability value between 0 and 1. For example, a component is highly likely to be recognized from a particular perspective, but it is less likely to be recognized from a different perspective or with partial shading or partial occlusion. This uncertainty can be taken into account when the actual 3D model is generated. Specifically, the degree of reliability can be taken into account when object identifications and/or poses from different directions or perspectives are combined. It is conceivable that the result with the greatest reliability will be used. However, it is also conceivable that the various (partial) information relating to object identifications and/or pose is fused in a suitable manner. Furthermore, it is conceivable that the expected object identifications and poses (from the target 3D model) are used to include, for example, results with an insufficient confidence value or to confirm the correctness thereof, and optionally to display same with a different format or a predetermined color in the feedback for the user.

In addition, the model can be trained to identify objects within or adjacent to components that do not match the expected or corresponding objects in the CAD pool. This enables further verification of the actual 3D model for correctness in that too many installed components of the assembly may be recognized incorrectly.

The determination of the actual orientation and actual position described above can be understood in one possible specific embodiment as a prediction of the 3D properties of each identified component, which-as already described above-can be carried out together with the identification of the component. In addition to a rotation matrix indicating the orientation of the component in 3D space, a 2D projection of a 3D center of the component on an image plane of the image data and a shape code vector of the component for determining the position of the component can also be estimated or determined, which requires embedding corresponding to a 3D model (for example a 3D CAD model) that corresponds to the identified component. In other words, the 3D position can be determined by determining the position in the 2D image from different perspectives, wherein orientation determination is possible by (pixel-by-pixel) segmentation and the object identification by means of the silhouette. The shape code vector can correspond to the identification in the embedding space and thus indicate the assignment of which component is involved, which is initially independent of its pose. It is also possible to estimate the location of the individual component in space with respect to other components or with respect to a known camera perspective.

An artificial intelligence-based model can be understood as meaning a model generated by machine learning and configured in the present case to identify individual components from a pool of components from the image data of the assembly and/or to determine the actual position and actual orientation thereof. Machine learning can be understood as meaning an “artificial” generation of knowledge from experience, in which an artificial system learns from examples and can generalize them after the learning phase has ended. That is to say that the examples are not simply memorized, rather patterns and regularities in the learning data are recognized. In this regard, the trained model can also assess unknown data (so-called learning transfer).

It is conceivable that the actual position and the actual orientation are identified and determined simultaneously, i.e. by means of a single model. This can be achieved by means of so-called end-2-end learning (E2E), where all the intermediate steps required for the result are integrated into a single model.

The pool of components can be understood as meaning a database that includes an identifier (for example an M12 screw) and an associated 3D model for a certain number of predetermined components. The model can be only specifically trained to recognize in the image data the components contained in the pool of components. For this purpose, (synthetic) image data of the respective components can be used to train the model.

The model may be in particular a so-called deep learning model. These generally require a large amount of training data for training, i.e. a large number of 2D CAD pairs, in order to obtain a model that is robust and suitable for generalization. However, realistic 2D CAD pairs with embedded/assembled 3D components can be generated in an automated manner using synthetic rendered images and their extensions, thus increasing the available training data and making it easier to achieve the high number of training data.

It should be noted here that the disclosure also relates to a method for training the artificial intelligence-based model described herein.

The use of the artificial intelligence-based model described above has the technical effect-inter alia-that the method can be used across assemblies, i.e. for assemblies of various types, as long as these assemblies have or consist of components from the pool of components. This provides flexibility in the use of the method, and so it is also suitable for small series production, since a model does not need to be retrained for each new or different assembly from previous assemblies.

The method may include obtaining a respective associated 3D model for each of the identified components, and determining the actual 3D model of the assembly by combining the obtained 3D models based on the determined actual positions and actual orientations thereof.

The compiling can be understood as meaning a digital reconstruction of the assembly, resulting in the actual 3D model. This provides the technical effect-inter alia-that the resulting actual 3D model is compatible with conventionally constructed 3D models, which can therefore be used as target 3D models. In other words, 3D models are regularly constructed using CAD (computer-aided design) programs. Like the actual 3D models, such 3D models consist of individually constructed models of individual components. The compatibility of the actual 3D model with the target 3D model, which, for example, originates from a development phase of the assembly, allows additional steps of adapting the actual 3D model to be avoided and thus the target-actual comparison can be carried out with comparatively low computing power.

Obtaining the 3D model may include loading the respective associated 3D model from the pool of components, which pool comprises a respective associated 3D model for each component of the pool.

This affords the advantage that the pool of 3D models can be managed and adapted independently, in particular independently of any artificial intelligence-based model used.

The target 3D model can be composed of 3D models of individual components that form the assembly. The comparison of the determined actual 3D model with the target 3D model of the assembly to check the correctness of the assembly may include a component-by-component comparison of the 3D models that form the target 3D model with the 3D models that form the actual 3D model.

This refers to the advantages described above in relation to determining the actual 3D model.

The component-by-component comparison of the 3D models that form the target 3D model with the 3D models that form the actual 3D model may include comparing the respective 3D models of the target 3D model and the actual 3D model as such in order to identify missing 3D models of individual components in the actual 3D model compared to the target 3D model and/or 3D models of individual components present in the actual 3D model but not in the target 3D model. In addition or alternatively, the component-by-component comparison of the 3D models that form the target 3D model with the 3D models that form the actual 3D model may include comparing a target position and target orientation with the actual position and actual orientation of the respective 3D models of the target 3D model and the actual 3D model in order to identify 3D models of individual components arranged differently from the target 3D model in the actual 3D model.

Specifically, this can mean that the actual 3D model, i.e. the virtual 3D reconstruction of the assembly, is compared with the target 3D model, i.e. the digital 3D model of the assembly (for example a 3D CAD model of the assembly), including a component part-by-component part or component-by-component evaluation of the correctness. This component-by-component evaluation of the correctness may include identifying missing components, identifying misaligned components, and/or identifying incorrect components (based on mismatched features of the 3D model).

This refers to the advantages described above, in relation to the component-by-component comparison of the actual 3D model. Furthermore, this specific embodiment offers the technical effect-inter alia-that not only an error regarding components existing in the assembly with regard to the position and orientation thereof, but also a completeness check is made possible.

The actual 3D model can be determined taking into account the 3D models contained in the target 3D model as such and/or the target position and target orientation of the 3D models contained in the target 3D model.

In other words, the assembling of the actual 3D model from the individual loaded 3D models of the identified components can be simplified in that, in addition to the actual orientations and actual positions known from the image data, the desired target positions and target orientations of the individual 3D models of the identified components known from the target 3D model are also taken into account. The target 3D model can be used as an initialization, where all parts of the target 3D model that have not been identified in the actual 3D model can be blocked out.

The determination of the actual 3D model may include identifying, based on an initially determined actual 3D model, at least one component of the assembly contained in the image data but incorrectly unidentified. The method can also comprise determining an actual position and actual orientation of the at least one component contained in the image data, but incorrectly unidentified, relative to the remaining, identified components and/or with respect to the predetermined camera perspective with which the image data was acquired, based on the image data. The method may include obtaining an associated 3D model of the at least one component contained in the image data, but incorrectly unidentified, and adapting the initially determined actual 3D model by adding the 3D model of the at least one component contained in the image data, but incorrectly unidentified, based on the determined actual position and actual orientation thereof in order to obtain the actual 3D model.

In addition or alternatively, the determination of the actual 3D model may include performing a plausibility check of the determined actual positions and the actual orientations of the identified components based on an initially determined actual 3D model. The method may include adapting the initially determined actual 3D model by adapting the positions and orientations of the 3D models contained in the initial actual 3D model based on a result of the plausibility check.

In other words, the digital 3D reconstruction already described above can initially lead to an unsatisfactory result, the so-called initial actual 3D model, since individual components in the image data may not be identified at all or the actual position and actual orientation thereof were initially incorrectly determined. In a post-processing step, this can be detected, for example, by a plausibility check based on the initial actual 3D model, for example due to gaps in the initial actual 3D model and/or coinciding/overlapping individual 3D models of the actual 3D model. A more detailed analysis of, inter alia, the image data can then be carried out and/or the initial actual 3D model can be optimized, for example using the target 3D model, in order to obtain the (final) actual 3D model to be used for the target-actual comparison.

It is also conceivable that, in order to resolve ambiguities in the identification of the individual components, for example due to glare or unfavorable illumination and/or challenging surface properties of the assembly, appearance-based considerations, such as methods using neural radiance fields (NeRF), can be used.

Furthermore, it is conceivable that a (local) 3D reconstruction of the assembly is used if ambiguities in the 2D CAD matching cannot be solved, i.e. if components contained in the image data cannot be uniquely assigned or cannot be assigned with sufficient certainty to one of the 3D models of the pool. In particular, this may include a 3D reconstruction of certain shapes/objects that would otherwise not be resolvable. A 3D comparison with the target 3D model can then be performed in various data formats, for example, inter alia, by displaying the component as a point cloud, with a mesh and/or as a voxel grid.

The method may include acquiring the image data of the assembly, advantageously from multiple perspectives. In this regard, reference is first made to the above explanations regarding the image data and the acquisition thereof. Furthermore, the acquisition of image data from multiple or different perspectives has the advantage over the acquisition of image data from a single perspective, i.e. over, for example, a single image, inter alia, that an ambiguity resulting from a projection of 3D onto 2D can be resolved with respect to a size of components along an image axis. It is conceivable that the method, in addition or alternatively, involves determining a particular perspective (for example using simultaneous localization and mapping (SLAM) and/or odometry (for example motion data integrated from acceleration IMU data)) from which the image data was captured or acquired.

The method may include outputting a piece of information comprising a result of the comparison of the determined actual 3D model with the target 3D model, optionally in an auditory and/or visual manner, optionally by driving a display device.

This may specifically mean that feedback is output to a user. For this purpose, an interface, for example in the form of a display, may be provided, which can be actuated according to the disclosure. Optionally, feedback of evaluation values of the 3D comparison described above can be output, for example by means of a visualization for the human user, for example including a recommendation for reworking and/or additional human testing. However, the interface is not limited to such a human machine interface (HMI), but it may, in addition or alternatively, be a data interface, via which a result of the target-actual comparison for a data processing device, which is, for example, connected to the interface in a wired and/or wireless manner, can be provided.

In this case, the possibility of interaction with the user is not only limited to the presentation of the result of the method, but the user can be supported by a corresponding information output, for example in the context of a guided user interaction when acquiring the image data, for example by displaying advantageous camera position, etc.

It is conceivable that a hierarchical approach will thus be implemented. This can extend the approach described above in such a way as to be able to provide a better view of hidden components of the assembly and/or possibilities to zoom into small or not easily identifiable components of the assembly. For this purpose, the uncertainty metrics described above from the output of the artificial intelligence-based model can be used to interact with the user about which parts after an initial acquisition of image data should be acquired again with changed or adjusted image acquisition settings (for example changed perspective or changed zoom or distance of the camera to assembly) as part of a second or additional image acquisition. In other words, since the comparison of the 3D data is essentially dependent on the actual 3D model, which, however, may contain different confidence values/reliability scores, it is conceivable that the actual 3D model is prepared as a color-coded visualization (for example green for all components with a confidence value greater than 90%, yellow for all components with confidence values up to 65% and red for all other components that are not recognized or recognized with deviations). A list of results with percentages would also be conceivable.

It should also be noted that, although the method described above is aimed at the use of a 3D model, it does not exclude the additional use of contour-based test methods known from the prior art, as described for example in U.S. Pat. No. 9,187,188 B2 and U.S. Pat. No. 10,242,438 B2.

The disclosure also relates to a data processing device configured to carry out the above-described method at least in part.

The data processing device may be a computer. The data processing device may be a distributed system; multiple individual physically separate data processing devices may be combined and jointly carry out the method, for example via the Internet.

The data processing device may be part of a data processing system which, in addition to the data processing device, has one or more sensors for capturing the image data and/or one or more interfaces, for example for user interaction.

It is conceivable that an embedding space is stored centrally on a server, while only object shape vectors which allow the identification of the components are exchanged.

The disclosure also relates to a computer program comprising instructions which, when the program is executed by a computer, cause the latter to carry out the above-described method at least in part.

The computer program may be software, for example comprising firmware and/or application software. Firmware can be understood as meaning software that is embedded (permanently) in electronic apparatus, such as in this case a sensor for image data acquisition, and performs basic functions there. The firmware may assume an intermediate position between the apparatus hardware (that is to say the physical portions of the apparatus) and any existing application software (the interchangeable programs of the apparatus, if any). The application software, which takes over the evaluation of the acquired image data according to the disclosure, can be executed on a computer connected to the sensor, for example a personal computer, a tablet, a smartphone, etc.

The disclosure also relates to a computer-readable medium, for example a computer-readable storage medium and/or a data signal, comprising instructions which, when the instructions are executed by a computer, cause the latter to carry out the method at least in part.

In particular, a computer-readable medium comprising the computer program described above can be provided.

The computer-readable medium may be any desired digital data storage apparatus, such as for example a USB stick, a hard disk, a flash memory, a CD-ROM, an SD card or an SSD card.

The computer program need not necessarily be stored on such a computer-readable storage medium in order to be made available to the computer, but rather can also be obtained as a data signal externally via the Internet or in some other way.

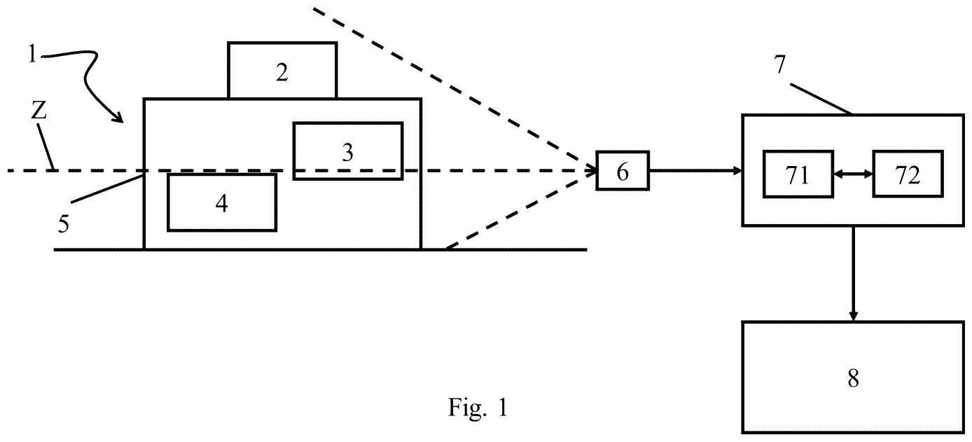

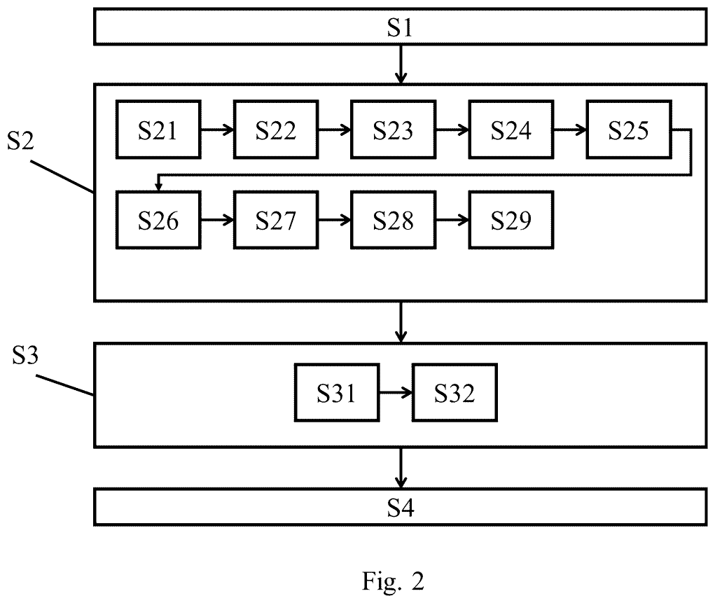

FIG. 1 schematically shows a side view of an assembly 1 comprising, multiple individual components 2-5. FIG. 1 also schematically shows a sensor 6 configured to acquire image data relating to the assembly 1 (FoV shown by dashed line), a computer 7 connected to the sensor 6, and a display 8 connected to the computer 7. The latter units 6-8 are part of a data processing system configured to carry out the method described in detail below. Said method is a computer-implemented method configured to check the correctness of the assembly 1. A flowchart of the method is schematically illustrated in FIG. 2.

As shown in FIG. 2, the method can be roughly divided into four steps S1-S4.

In a first step S1 of the method, the sensor 6, for example a camera, is used to acquire image data relating to the assembly 1 (optionally from multiple perspectives, only one perspective is shown here in FIG. 1 for simplicity) and output same to the computer 7.

In a second step S2 of the method, based on the image data relating to the assembly 1 acquired in the first step S1, an actual 3D model of the assembly is determined by means of a computer program stored in a memory 72 of the computer 7 and executed by a processor 71 of the computer 7. The second step S2 is explained in more detail below.

In a first substep S21 of the second step S2, the components 2-5 that form the assembly are identified in the image data captured by the sensor 6 and an actual position and actual orientation of the identified components 2-5 are determined based on the image data. The actual position and actual orientation of the identified components 2-5 can be carried out, for example relative to one another and/or with respect to a predetermined camera perspective with which the image data was acquired, in particular an image axis Z.

The identification of the multiple components 2-5 and the determination of the actual position and actual orientation of the identified components 2-5 is carried out in the first substep S21 by means of a single artificial intelligence-based model. The model is trained and thus configured to identify, from the image data relating to the assembly 1, both individual components 2-5 of the assembly 1, which correspond to components from a pool of components, and to determine their actual position and actual orientation at the same time.

In a second substep S22 of the second step S2, a respective associated 3D model for each of the identified components 2-5 is obtained by loading the respective associated 3D model from the pool of components, which pool is stored in the memory of the computer 7 and comprises a respective associated 3D model for each component of the pool.

In a third substep S23 of the second step S2, an initial or first actual 3D model of the assembly 1 is determined by combining the obtained 3D models based on the determined actual positions and actual orientations thereof and taking into account 3D models contained in a target 3D model of the assembly as such and/or the target position and target orientation of the 3D models contained in the target 3D model (which in turn can refer to the 3D models corresponding to the individual components 3-5 relative to one another or (in absolute terms) to the camera perspective). The target 3D model is composed of 3D models of individual components 2-5 that form the assembly and includes information about the respective target position and target orientation of these 3D models.

More specifically, an actual position and actual orientation of the respectively loaded 3D model in the actual 3D model (which in turn can refer to the 3D models corresponding to the individual components 3-5 relative to one another or (in absolute terms) to the camera perspective) can be set as equal to the determined actual position and actual orientation of the respective specific individual components 2-5. For example, the target 3D model can be taken into account to the extent that actual positions and actual orientations of 3D models in the first actual 3D model deviating slightly or within a predetermined tolerance range are adapted based on the target positions and target orientations of the individual 3D models contained in the target 3D model in order to generate a coherent first actual 3D model.

This generated initial or first actual 3D model can now be (further) optimized as described below.

For this purpose, in a fourth substep S24 of the second step S2, a check is carried out based on the initially determined actual 3D model to determine whether a component 4 of the assembly 1 contained in the image data, but incorrectly unidentified, is present and, if so, this is identified (see first substep S21 of the second step S2). Here, it is assumed, for example, that the component 4 has not been identified or has not been recognized reliably enough. For example, to identify the unidentified component 4 of the assembly 1, the initial actual 3D model can be subjected to a plausibility check. For example, the first actual 3D model, as described in detail below with reference to a third step S3 of the method, can be compared with a target 3D model and, if it is determined that the component 4 is not contained in the actual 3D model but is already contained in the target 3D model, the image data can then be examined again specifically for the component 4. If this verification is sufficiently successful (i.e. has a sufficiently high confidence value), this component 4 can be used in the same way as the previously unambiguously identified components. This is just one example of the plausibility check and other methods are also conceivable.

In a fifth substep S25 of the second step S2, based on the image data, an actual position and actual orientation of the incorrectly unidentified component 4 relative to the remaining, identified components 2, 3, 5 and/or with respect to the predetermined camera perspective with which the image data were acquired (see first substep S21 of second step S2) are determined.

In a sixth substep S26, an associated 3D model of the incorrectly unidentified components 4 is obtained (see second substep S22 of the second step S2).

In a seventh substep S27, the initially determined actual 3D model is adapted by adding the loaded 3D model of the incorrectly unidentified component 4 based on its determined actual position and actual orientation (see third substep S23 of second step S2) to obtain a second actual 3D model.

The check of the initial actual 3D model was described above for the sake of completeness. In addition or alternatively, a check can also be carried out to determine whether the identified components 2-5 of the assembly 1 are correctly arranged in the generated actual 3D model. In the present case, this is carried out based on the second, adapted actual 3D model. However, it would also be conceivable to carry out an eighth and ninth substep S28, S29 of the second step S2, described below, based on the first or initially generated actual 3D model.

In the eighth substep S28 of the second step S2, a plausibility check of the determined actual positions and the actual orientations of the identified components 2-5 is performed based on an initially determined actual 3D model. More specifically, the second actual 3D model can be compared with the target 3D model, for example, as described in detail below with reference to the third step S3 of the method. If it is determined that a 3D model of one of the components 2-5, for example the 3D model of the component 4, is arranged in the target 3D model differently to the 3D model of the component 4, then the image data can be examined again specifically for this component 4. This is just one example of the plausibility check and other methods are also conceivable. It is then possible to determine an adapted actual position and actual orientation of the component 4 and thus an adapted actual position and actual orientation of the 3D model corresponding to the component 4 in the second actual 3D model in the manner described above (see third substep S23 of the second step S2).

In the ninth substep S29 of the second step S2, the second determined actual 3D model is adapted by adapting the actual positions and actual orientations of the 3D models contained in the second actual 3D model based on a result of the eighth substep S28. In the present example, this may mean that the actual position and actual orientation of the 3D model corresponding to the component 4 in the second actual 3D model is updated based on the adjusted actual position and actual orientation of said second 3D model determined in the eighth substep S28 of the second step 2. This results in a final or third actual 3D model, which is referred to below as the actual 3D model.

In the third step S3 of the method, the actual 3D model determined in the second step S2 is compared, in a component-by-component manner, i.e. 3D model for 3D model of the two 3D models of the assembly 1, with the target 3D model of the assembly 1 stored in the memory 72 in order to check the correctness of the assembly 1 in turn by means of the computer program stored in the memory 72 and executed by the processor 71. In other words, the comparison of the determined actual 3D model with the target 3D model of the assembly 1 to check the correctness of the assembly 1 comprises a component-by-component comparison of the 3D models that form the target 3D model with the 3D models that form the actual 3D model. As described above, the target 3D model is composed of 3D models of individual components 2-5 that form the assembly and includes the information regarding the target orientation and the target position of the individual 3D models. The third step S3 is explained in more detail below. The results from the optimization steps S24-S 29 described above can optionally be used in part.

In a first substep S31 of the third step S3, that is to say the component-by-component comparison, the respective 3D models of the target 3D model and the actual 3D model as such are compared in order to identify missing 3D models of individual components 2-5 in the actual 3D model compared to the target 3D model and/or 3D models of individual components 2-5 present in the actual 3D model but not in the target 3D model.

In a second substep S32 of the third step S3, that is to say the component-by-component comparison, the target position and target orientation are compared with the actual position and actual orientation of the respective 3D models of the target 3D model and the actual 3D model in order to identify 3D models of individual components 2-5 arranged differently from the target 3D model in the actual 3D model.

In a fourth step S4 of the method, a piece of information including a result of the comparison of the determined actual 3D model with information comprising the target 3D model, i.e. the result of the third step S3, is output, in the present case visually by actuating the display device 8 (including generating a corresponding control signal by means of the computer program stored in the memory 72 and executed by the processor 72).

The steps S1-S4 and sub-steps S21-S29, S31, S32 described above represent a possible sequence of the method, with different sequences also being conceivable. The individual steps S1-S4 and substeps S21-S29, S31, S32 do not necessarily have to be implemented here as separate steps S1-S4 and substeps S21-S29, S31, S32 using software. Instead, multiple steps S1-S4 and/or substeps S21-S29, S31, S32 can also be combined. For example, the substeps S24-S26 of the second step S2 can be combined in a single (sub) step.

### LIST OF REFERENCE SYMBOLS

1 Assembly
2-5 Components of the assembly
6 Sensor, for example camera
7 Computer
71 Processor
72 Memory
8 Display device, for example display
S1-S4 Method steps

What is claimed is:

1. A computer-implemented method configured to check a correctness of an assembly, the method comprising:
determining an actual 3D model of the assembly based on image data relating to the assembly, and
comparing the determined actual 3D model with a target 3D model of the assembly to check the correctness of the assembly.

2. The computer-implemented method as claimed in claim 1, the method further comprising acquiring the image data relating to the assembly.

3. The computer-implemented method as claimed in claim 1, the method further comprising:
identifying in the image data multiple components that form the assembly, and
determining, based on the image data, an actual position and actual orientation of the identified components relative to one another.

4. The computer-implemented method as claimed in claim 1, the method further comprising:
identifying in the image data multiple components that form the assembly, and
determining, based on the image data, an actual position and actual orientation of the identified components with respect to a predetermined camera perspective with which the image data was acquired.

5. The computer-implemented method as claimed in claim 3, wherein the multiple components are identified by a model that is based on artificial intelligence and trained to identify individual components from a pool of components.

6. The computer-implemented method as claimed in claim 3, wherein the actual position and actual orientation of the identified components are determined by a model that is based on artificial intelligence and trained to determine the actual position and actual orientation of said components from the image data relating to the assembly.

7. The computer-implemented method as claimed in claim 3, the method further comprising:
obtaining a respective associated 3D model for each of the identified components, and
determining the actual 3D model of the assembly by combining the obtained 3D models based on the determined actual positions and actual orientations thereof.

8. The computer-implemented method as claimed in claim 7, wherein the obtaining of the 3D models includes loading the respective associated 3D model from the pool of components, which includes for each component of the pool the respective associated 3D model.

9. The computer-implemented method as claimed in claim 7, wherein:
the target 3D model is composed of 3D models of individual components that form the assembly, and
the comparison of the determined actual 3D model with the target 3D model of the assembly to check the correctness of the assembly includes a component-by-component comparison of the 3D models that form the target 3D model with the 3D models that form the actual 3D model.

10. The computer-implemented method as claimed in claim 9, wherein the component-by-component comparison of the 3D models that form the target 3D model with the 3D models that form the actual 3D model includes at least one of:
-comparing the respective 3D models of the target 3D model and the actual 3D model as such to identify at least one of missing 3D models of individual components in the actual 3D model compared to the target 3D model and 3D models of individual components present in the actual 3D model but not in the target 3D model, and
comparing a target position and target orientation with an actual position and actual orientation of the respective 3D models of the target 3D model and the actual 3D model to identify 3D models of individual components arranged differently to the target 3D model in the actual 3D model.

11. The computer-implemented method as claimed in claim 9, wherein the actual 3D model is determined based on at least one of the 3D models contained in the target 3D model as such and the target position and target orientation of the 3D models contained in the target 3D model.

12. The computer-implemented method as claimed in claim 7 wherein the method further comprises acquiring the image data relating to the assembly, and wherein the determination of the actual 3D model includes:
identifying, based on an initially determined actual 3D model, at least one component of the assembly contained in the image data that was incorrectly not identified,
determining, based on the image data, an actual position and actual orientation of the at least one component contained in the image data that was incorrectly not identified, relative to the remaining, identified components and/or with respect to the predetermined camera perspective with which the image data was acquired,
obtaining an associated 3D model of the at least one component contained in the image data that was incorrectly not identified, and
adapting the initially determined actual 3D model by adding the 3D model of the at least one component contained in the image data that was incorrectly not identified, based on the determined actual position and actual orientation thereof in order to obtain the actual 3D model.

13. The computer-implemented method as claimed in claim 7, wherein the method further comprises acquiring the image data relating to the assembly, and wherein the determination of the actual 3D model includes:
performing a plausibility check of the determined actual positions and the actual orientations of the identified components based on an initially determined actual 3D model, and
adapting the initially determined actual 3D model by adapting actual positions and actual orientations of the 3D models contained in the initial actual 3D model based on a result of the plausibility check.

14. The computer-implemented method as claimed in claim 1, the method further comprising outputting a piece of information including a result of the comparison of the determined actual 3D model with the target 3D model.

15. A data processing device, wherein the device is configured to carry out the method as claimed in claim 1.

16. A non-transitory computer-readable medium comprising instructions which, when the instructions are executed by a computer, cause the computer to carry out the method as claimed in claim 1.
